(19) United States
(12) Patent Application Publication
(10) Pub. No.: US 2015/0113230 A1
(43) Pub. Date: Apr. 23, 2015

(54) DIRECTORY STORAGE METHOD AND QUERY METHOD, AND NODE CONTROLLER

(71) Applicant: Huawei Technologies Co., Ltd., Shenzhen (CN)

(72) Inventor: Yongbo CHENG, Chengdu (CN)

(21) Appl. No.: 14/515,940

(22) Filed: Oct. 16, 2014

(30) Foreign Application Priority Data
Oct. 17, 2013 (CN) 201310487653.2

(51) Int. Cl. G06F 12/08

(52) U.S. Cl. CPC G06F 12/0824; G06F 2212/622; G06F 2212/271
USPC 711/145

(57) ABSTRACT

The present invention discloses a directory storage method and a directory storage node controller. The method includes: obtaining, by a node controller NC in a local node, a storage address of a data block in a CPU in the local node, where the data block is read by a remote node; determining first content and second content that are respectively located in a first specific bit and a second specific bit of the storage address; determining, according to the first content and from each preset storage space used for storing a directory, a storage space in which an addressing address matches the first content; and correspondingly storing the second content and the directory in the determined storage space.

### CROSS-REFERENCE TO RELATED APPLICATION

This application claims priority to Chinese Patent Application No. 201310487653.2, filed on Oct. 17, 2013, which is hereby incorporated by reference in its entirety.

### TECHNICAL FIELD

The present invention relates to the field of computer technologies, and in particular, to a directory storage method and query method, and a node controller.

### BACKGROUND

In a cache coherence non-uniform memory access (Cache Coherence Non-Uniform Memory Access, CC-NUMA) system formed by high-performance central processing units (Central Processing Units, CPUs), because interconnection and expansion capabilities of the CPU itself are limited, it is necessary to group multiple CPUs in the CC-NUMA system into different nodes (Node), and then a node controller (Node Controller, NC) performs expansion for the multiple CPUs, so as to increase the number of CPUs that can concurrently operate, thereby improving performance of the CC-NUMA system.

FIG. 1 shows a schematic diagram of a simple structure of a CC-NUMA system. The CC-NUMA system shown in FIG. 1 totally includes N+1 nodes, which are Node0 to NodeN separately. Node0 is used as an example. It includes one NC and n CPUs controlled by the NC. Each CPU has its own cache (Cache), and the Cache may be specifically an L3 Cache, that is, an L3 marked in FIG. 1. In addition, memory expansion may further be performed for each CPU. For example, memory expansion for a CPU may be implemented based on an existing memory of the CPU by newly adding a dual in-time memory module (Dual in-line memory module, DIMM) shown in FIG. 1.

In the system shown in FIG. 1, each CPU has its own L3 Cache and memory expansion may be performed. Any CPU in this system may perform coherent access to other CPUs in this system besides itself.

According to the prior art, each NC needs to save a Dir, that is, a directory (Directory), shown in FIG. 1 to record a condition in which data, in a memory of a CPU in a node on which the NC is located, is buffered by a CPU of another node (that is, another node different from the node on which the NC is located, also referred to as a remote node), so as to maintain data consistency among different nodes. For example, it is assumed that a CPU in Node1 buffers data in a memory of a CPU in Node0, an NC that controls Node0 needs to use a Dir to record a condition in which the data is buffered by Node1, and mark in the directory a state (may be shared or exclusive) of the data applied by the CPU in Node1. Memory expansion for a CPU may enable the CPU to have a memory of a large capacity. Therefore, to fully record a condition in which data in a memory of a CPU is buffered by a remote node, a storage space of a directory may also be expanded by newly adding a DIMM to an NC maintaining the directory, so that demands of a great number of directories for storage spaces are satisfied.

Generally, a correspondence between a directory and the amount of data in a memory of a CPU is as follows: One directory corresponds to one cache line (Cache Line) in the memory of the CPU. That is, each directory records a condition in which data of one Cache Line is buffered by a remote node. A size of the amount of data of one Cache Line may be 512 bits.

CPU Ivy-Bridge EX is used as an example. A capacity of its L3 Cache is 37.5 MB. Therefore, the maximum number of Cache Lines that can be actually buffered by each CPU like this is 37.5 MB/64B=600K. For a 32P CC-NUMA system, that is, a CC-NUMA system including 32 CPUs, all remote nodes corresponding to any node in this system totally includes 30 CPUs. Therefore, the maximum number of directories that need to be maintained by an NC of this node is 30×600K=18M. For any CPU, a buffer state of data in a remote node is changeable. Therefore, a directory maintained by the NC dynamically changes. The 32P CC-NUMA system is still used as an example. It is assumed that a condition in which data X in a CPU of a node is buffered by a remote node changes, a directory maintained by an NC in this node needs to change correspondingly. Particularly, in a case in which the number of directories maintained by the NC reaches a maximum number, to save a directory corresponding to the data X, the NC can only free a storage space for the directory corresponding to data X by deleting a directory, and notifying a CPU recorded in the directory to delete corresponding data.

It can be learned from the foregoing directory updating manner that, if a storage space used by an NC to maintain a directory is excessively small, a case in which a CPU is notified to delete data of a remote node and buffered by the CPU frequently occurs in a CC-NUMA system, thereby severely affecting using, by the CPU, the data of the remote node buffered by the CPU.

A “full directory technology” is proposed in the prior art to avoid the foregoing problems. A core idea of this technology is that according to a maximum memory capacity of a CPU, a directory storage space corresponding to the maximum number of Cache Lines that can be supported by the maximum memory capacity is reserved on an NC. For example, if it is assumed that one node controls two CPUs, where a total memory capacity of the two CPUs is 2 TB after memory expansion is separately performed for the two CPUs, and it is assumed that the amount of data of one Cache Line is 512 bits, it is required to reserve a storage space on the NC for each directory respectively corresponding to each Cache Line in the CPU, that is, the number of directories that need to be stored on the NC should be 2 TB/64 Byte=32G, so as to avoid impact caused by an insufficient directory storage space on using, by the CPU, data acquired from a remote node. According to such a demand, if it is assumed that a size of one directory is 8 bits, an NC needs to have a 32 GByte storage space, which definitely generates a great number of demands for storage resources.

### SUMMARY

Embodiments of the present invention provide a directory storage method and a directory storage node controller, which are used to resolve a problem in the prior art that a great number of demands for storage resources are generated because of an intention to reduce impact caused by an insufficient directory storage space of the NC on using, by a CPU, data of a remote node and buffered by the CPU.

The embodiments of the present invention further provide a directory query method and a directory query node controller.

The following technical solutions are adopted in the embodiments of the present invention:

According to a first aspect, a directory storage method is provided, where the directory is used for recording a condition in which a data block in a central processing unit CPU in a local node is buffered by a remote node, and the method includes: obtaining, by a node controller NC in the local node, a storage address of the data block in the CPU, where the data block is read by the remote node and is in the CPU; determining first content and second content that are respectively located in a first specific bit and a second specific bit of the storage address, where the first content and the second content jointly include all content of the storage address, and a bit number of the first specific bit is greater than a predetermined bit number threshold and is less than a total bit number of the storage address, where the bit number threshold satisfies: the total number of different storage spaces that can be addressed according to the bit number threshold is not less than a sum of the maximum number of data blocks that can be buffered by each CPU in all remote nodes, where the remote nodes are in a same cache coherence non-uniform memory access CC-NUMA system with the local node; determining, according to the first content and from each preset storage space used for storing a directory, a storage space in which an addressing address matches the first content; and correspondingly storing the second content and the directory in the determined storage space.

With reference to the first aspect, in a first possible implementation manner, the first content includes a first index portion and a second index portion, and the determining, according to the first content and from each preset storage space used for storing a directory, a storage space in which an addressing address matches the first content specifically includes: determining, according to the first index portion and from each preset storage space set used for storing a directory, a storage space set in which the addressing address matches the first index portion; and determining, according to the second index portion and from the determined storage space set, a storage space in which the addressing address matches the second index portion.

With reference to the first aspect or the first possible implementation manner of the first aspect, in a second possible implementation manner, the correspondingly storing the second content and the directory in the determined storage space specifically includes: determining one storage subspace from multiple storage subspaces obtained by dividing the determined storage space according to a predetermined storage space division manner; and correspondingly storing the second content and the directory in the determined storage subspace.

With reference to the first aspect, in a third possible implementation manner, the correspondingly storing the second content and the directory in the determined storage space specifically includes: determining whether the determined storage space has stored another directory; when it is determined that the determined storage space has not stored another directory, correspondingly storing the second content and the directory in the determined storage space; and when it is determined that the determined storage space has stored another directory, correspondingly storing the second content and the directory in the determined storage space after the determined storage space is freed.

According to a second aspect, a directory query method is provided, including: obtaining, by a node controller NC in a local node, a storage address of a data block in a central processing unit CPU in the local node; determining first content and second content that are respectively located in a first specific bit and a second specific bit of the storage address, where the first content and the second content jointly include all content of the storage address, and a bit number of the first specific bit is greater than a predetermined bit number threshold and is less than a total bit number of the storage address, where the bit number threshold satisfies: the total number of different storage spaces that can be addressed according to the bit number threshold is not less than a sum of the maximum number of data blocks that can be buffered by each CPU in all remote nodes, where the remote nodes are in a same cache coherence non-uniform memory access CC-NUMA system with the local node; querying, according to the first content and from each preset storage space used for storing a directory, a storage space in which an addressing address matches the first content; and querying, according to the second content and from a found storage space in which the addressing address matches the first content, a directory that is correspondingly stored with the second content, where the directory is used for recording a condition in which a data block is buffered by a remote node.

With reference to the second aspect, in a first possible implementation manner, the first content includes a first index portion and a second index portion, and the querying, according to the first content and from each preset storage space used for storing a directory, a storage space in which an addressing address matches the first content specifically includes: querying, according to the first index portion and from each preset storage space set used for storing a directory, a storage space set in which the addressing address matches the first index portion; and querying, according to the second index portion and from a found storage space set in which the addressing address matches the first index portion, a storage space in which the addressing address matches the second index portion.

With reference to the second aspect or the second possible implementation manner of the second aspect, in a third possible implementation manner, the querying the directory according to the second content and from the found storage space in which the addressing address matches the first content specifically includes: querying, according to the second content and from multiple storage subspaces, the directory that is correspondingly stored with the second content, where the multiple storage subspaces are obtained by dividing, according to a predetermined storage space division manner, the determined storage space in which the addressing address matches the first content.

According to a third aspect, a directory storage node controller is provided, where the directory is used for recording a condition in which a data block in a central processing unit CPU in a local node is buffered by a remote node, the local node is a node on which the node controller is located, and the node controller includes: an address obtaining unit, configured to obtain a storage address of the data block in the CPU, where the data block is read by the remote node and is in the CPU; a content determining unit, configured to determine first content and second content that are respectively located in a first specific bit and a second specific bit of the storage address, where the first content and the second content jointly include all content of the storage address, and a bit number of the first specific bit is greater than a predetermined bit number threshold and is less than a total bit number of the storage address, where the bit number threshold satisfies: the total number of different storage spaces that can be addressed according to the bit number threshold is not less than a sum of the maximum number of data blocks that can be buffered by each CPU in all remote nodes, where the remote nodes are in a same cache coherence non-uniform memory access CC-NUMA system with the local node; a storage space determining unit, configured to determine, according to the first content and from each preset storage space used for storing a directory, a storage space in which an addressing address matches the first content; and a directory storage performing unit, configured to correspondingly store the second content and the directory in the determined storage space.

With reference to the third aspect, in a first possible implementation manner, the first content includes a first index portion and a second index portion, and the storage space determining unit is specifically configured to: determine, according to the first index portion and from each preset storage space set used for storing a directory, a storage space set in which the addressing address matches the first index portion; and determine, according to the second index portion and from the determined storage space set, a storage space in which the addressing address matches the second index portion.

With reference to the third aspect or the first possible implementation manner of the third aspect, in a second possible implementation manner, the directory storage performing unit is specifically configured to: determine one storage subspace from multiple storage subspaces obtained by dividing the determined storage space according to a predetermined storage space division manner; and correspondingly store the second content and the directory in the determined storage subspace.

With reference to the third aspect, in a third possible implementation manner, the directory storage performing unit is specifically configured to: determine whether the determined storage space has stored another directory; when it is determined that the determined storage space has not stored another directory, correspondingly store the second content and the directory in the determined storage space; and when it is determined that the determined storage space has stored another directory, correspondingly store the second content and the directory in the determined storage space after the determined storage space is freed.

According to a fourth aspect, a directory query node controller is provided, including: a storage address obtaining unit, configured to obtain a storage address of a data block in a central processing unit CPU, where the CPU is a CPU in a local node on which the node controller is located; a content determining unit, configured to determine first content and second content that are respectively located in a first specific bit and a second specific bit of the storage address, where the first content and the second content jointly include all content of the storage address, and a bit number of the first specific bit is greater than a predetermined bit number threshold and is less than a total bit number of the storage address, where the bit number threshold satisfies: the total number of different storage spaces that can be addressed according to the bit number threshold is not less than a sum of the maximum number of data blocks that can be buffered by each CPU in all remote nodes, where the remote nodes are in a same cache coherence non-uniform memory access CC-NUMA system with the local node; a storage space querying unit, configured to query, according to the first content and from each preset storage space used for storing a directory, a storage space in which an addressing address matches the first content; and a directory querying unit, configured to query, according to the second content and from a found storage space in which the addressing address matches the first content, a directory that is correspondingly stored with the second content, where the directory is used for recording a condition in which a data block is buffered by a remote node.

With reference to the fourth aspect, in a first possible implementation manner, the first content includes a first index portion and a second index portion, and the storage space querying unit is specifically configured to: query, according to the first index portion and from each preset storage space set used for storing a directory, a storage space set in which the addressing address matches the first index portion; and query, according to the second index portion and from a found storage space set in which the addressing address matches the first index portion, a storage space in which the addressing address matches the second index portion.

With reference to the fourth aspect or the first possible implementation manner of the fourth aspect, in a second possible implementation manner, the directory querying unit is specifically configured to: query, according to the second content and from multiple storage subspaces, the directory that is correspondingly stored with the second content, where the multiple storage subspaces are obtained by dividing, according to a predetermined storage space division manner, the determined storage space in which the addressing address matches the first content.

Beneficial effects of the embodiments of the present invention are as follows:

In the foregoing solutions provided in the embodiments of the present invention, a bit number of a first specific bit is set to be greater than a predetermined bit number threshold and less than a total bit number of a data storage address; and the total number of different storage spaces that can be addressed according to the bit number threshold is not less than a sum of the maximum number of data blocks that can be buffered by each CPU in all remote nodes, where the remote nodes are in a same CC-NUMA system with a local node. Therefore, when addressing is performed according to the bit number of the first specific bit, the maximum number of different addressing addresses that can be addressed does not exceed the maximum number of different addressing addresses that can be addressed according to a bit number of the data storage address; in addition, the maximum number of the different addressing addresses that can be addressed is not less than a sum of the maximum number of the data blocks that can be buffered by each CPU in all remote nodes either, where the remote nodes are in the same CC-NUMA system with the local node. Therefore, compared with a full directory technology in the prior art, the solutions provided in the embodiments of the present invention not only reduce impact caused by an insufficient directory storage space of an NC on using, by a CPU, data of a remote node and buffered by the CPU but also greatly reduce the number of demands of a directory for storage resources.

### BRIEF DESCRIPTION OF DRAWINGS

FIG. 1 is a schematic diagram of a simple structure of a CC-NUMA system;

FIG. 2 is a specific schematic flowchart of a directory storage method according to an embodiment of the present invention;

FIG. 3 is a specific schematic flowchart of a directory query method according to an embodiment of the present invention;

FIG. 4 is a mapping manner between a CPU DIMM and an NC DIMM used in Embodiment 1;

FIG. 5 is a schematic diagram of a format of information stored in any storage subspace of Way0 to Way15;

FIG. 6 is a schematic division diagram of 7 bits used for storing a Dir;

FIG. 7 is a schematic flowchart of a simple implementation process of a data read operation across nodes in the CC-NUMA system shown in FIG. 1;

FIG. 8 is a schematic diagram of initiating, by a CPU of Node 1, a read request for a memory address A to a CPU of Node0;

FIG. 9 is a schematic diagram of selecting content from different bits of the memory address A as an Index, a Mux, and a Tag separately;

FIG. 10 is a schematic diagram of a protocol processing engineer and a storage controller disposed in NC0;

FIG. 11 is a schematic diagram of an addressing manner in Embodiment 1;

FIG. 12 is a schematic diagram of a mapping manner between an address of a Cache Line and an address of a storage space in an NC DIMM in Embodiment 2;

FIG. 13 is a schematic diagram of dividing a storage space into 8 storage subspaces in Embodiment 2;

FIG. 14 is a schematic diagram of a mapping manner between an address of a Cache Line and an address of a storage space in an NC DIMM in Embodiment 3;

FIG. 15 is a schematic diagram of a specific structure of a directory storage NC according to an embodiment of the present invention;

FIG. 16 is a schematic diagram of a specific structure of a directory query NC according to an embodiment of the present invention;

FIG. 17 is a schematic diagram of a specific structure of another directory storage NC according to an embodiment of the present invention; and

FIG. 18 is a schematic diagram of a specific structure of another directory query NC according to an embodiment of the present invention.

### DESCRIPTION OF EMBODIMENTS

To resolve a problem in the prior art that a great number of demands for storage resources are generated because of an intention to reduce impact caused by an insufficient directory storage space of an NC on using, by a CPU, data of a remote node and buffered by the CPU, embodiments of the present invention provide a directory storage method and a directory storage node controller. The following describes the embodiments of the present invention with reference to the drawings for the specification. It should be understood that the embodiments described herein are merely used to illustrate and explain the present invention but are not intended to limit the present invention. The embodiments of the present specification and features in the embodiments may be mutually combined in a case in which they do not conflict with each other.

First, an embodiment of the present invention provides a directory storage method. A specific schematic flowchart of the method is shown in FIG. 2, which mainly includes the following steps:

Step 21: An NC in a local node obtains a storage address of a data block in a CPU, where the data block is read by a remote node and is in the CPU in the local node.

For example, the storage address that is of the data block in the CPU and that the remote node wants to access may be obtained from a data access request sent by the remote node. The storage address may be of 16 bits, 32 bits, or the like. This embodiment of the present invention constitutes no limitation thereto.

In this embodiment of the present invention, step 21 may be performed by triggering the data access request sent by the remote node; or step 21 may be performed after it is determined that the remote node successfully accesses the data block that the remote node wants to access. This embodiment of the present invention constitutes no limitation thereto either.

Step 22: The NC determines first content and second content that are respectively located in a first specific bit and a second specific bit of the obtained storage address.

This embodiment of the present invention may not constitute a limitation on bit numbers of the first specific bit and the second specific bit. However, it should be noted that the first content in the first specific bit and the second content in the second specific bit jointly include all content of the storage address. For example, when the storage address is 0000 0000 0000 0001, the first content and the second content should jointly cover all content of the storage address, that is, they should cover “0000 0000 0000 0001”. Specifically, for example, the first content may be high 8 bit content “0000 0000” in the storage address, and the second content may be low 8 bit content “0000 0001” in the storage address; or, for example, the first content may be high 10 bit content “0000 0000 00” in the storage address, and the second content may be low 8 bit content “0000 0001” in the storage address.

In this embodiment of the present invention, because content in the first specific bit and content in the second specific bit jointly include all content of the storage address, for a storage address of any data block, a unique directory can be jointly mapped by using the content in the first specific bit and the content in the second specific bit. For a specific mapping manner, refer to step 23 and step 24 described below. Details are not described herein again.

In addition, it should be noted that a bit number of the first specific bit may be greater than a predetermined bit number threshold and less than a total bit number of the obtained storage address. The bit number threshold satisfies: the total number of different storage spaces that can be addressed according to the bit number threshold is not less than a sum of the maximum number of data blocks that can be buffered by each CPU in all remote nodes, where the remote nodes are in a same CC-NUMA system with the local node. It can be learned from the limitation on the bit number of the first specific bit that, compared with a full directory technology in the prior art, the maximum number of different addressing addresses that are addressed according to the bit number of the first specific bit does not exceed the maximum number of different addressing addresses that can be addressed according to a bit number of a storage address of a data block.

Step 23: Determine, according to the determined first content and from each preset storage space used for storing a directory, a storage space in which an addressing address matches the first content.

The total number of the foregoing preset storage spaces used for storing a directory may be equal to the total number of different addressing addresses that can be addressed according to the bit number of the first specific bit.

It can be learned from the foregoing description that the bit number of the first specific bit is greater than the predetermined bit number threshold and less than the total bit number of the obtained storage address. It can be learned from this condition that the maximum number of the different addressing addresses that are addressed according to the bit number of the first specific bit does not exceed the maximum number of the different addressing addresses that can be addressed according to the bit number of the storage address of the data block; in addition, the maximum number of the different addressing addresses that can be addressed is not less than a sum of the maximum number of the data blocks that can be buffered by each CPU in all remote nodes either, where the remote nodes are in a same CC-NUMA system with the local node. Therefore, compared with a full directory technology in the prior art, the solution provided in this embodiment of the present invention reduces impact caused by an insufficient directory storage space of an NC on using, by a CPU, data of a remote node and buffered by the CPU and, greatly reduces the number of demands of a directory for storage resources.

Step 24: In the determined storage space having the addressing address that matches the first content, correspondingly store the second content and a directory corresponding to the data block that is read by the remote node and is in the CPU.

In this embodiment of the present invention, the directory corresponding to the data block is information that represents a condition in which the data block is buffered by the remote node. The second content which is correspondingly stored with the directory is mainly used, together with the first content in the first specific bit, as an only basis for determining a storage location of this directory when it is necessary to query the directory later. For a specific process of implementing directory query, refer to a directory query method described in the following in the specification.

Optionally, in the method provided in this embodiment of the present invention, the first content may include a first index portion and a second index portion. Based on the first index portion and the second index portion, a specific implementation manner of the foregoing step 23 may include:

first, determining, according to the first index portion and from each preset storage space set used for storing a directory, a storage space set in which the addressing address matches the first index portion; and

then, determining, according to the second index portion and from the determined storage space set, a storage space in which the addressing address matches the second index portion.

For example, it is assumed that a bit number of the second index portion is 1, the total number of different addressing addresses that can be addressed according to the bit number of the second index portion is 2. Therefore, it can be concluded that the storage space set whose addressing address matches the first index portion includes two storage spaces that respectively have addressing addresses 1 and 0. In this scenario, when the second index portion is 0, a storage space that has the addressing address “0” can be determined from the two storage spaces, to serve as a storage space used for correspondingly storing the second content and the directory corresponding to the data block read by the remote node.

In this embodiment of the present invention, the bit number of the second index portion may be flexibly set, so as to flexibly divide the storage space. This embodiment of the present invention constitutes no limitation on a specific bit number of the second index portion.

Further, in this embodiment of the present invention, the storage space may further be divided into multiple storage subspaces; and the second content and the directory corresponding to the foregoing data block may be stored in a storage subspace. Specifically, an implementation process of correspondingly storing the second content and the directory corresponding to the data block in the foregoing determined storage space may include:

first, determining one storage subspace from the multiple storage subspaces obtained by dividing the determined storage space according to a predetermined storage space division manner; and

then, correspondingly storing the second content and the directory corresponding to the data block in the determined storage subspace.

For example, it is assumed that a size of a storage space set to which an addressing address, addressed according to the first index portion in the first content, points is 512 bits; and it is assumed that a bit number of the second index portion in the first content is 1, in this case, the storage space set actually includes two storage spaces. If it is further assumed that one storage space can be divided into 16 storage subspaces with a same size, when the second content and the directory are being stored, one storage subspace may be selected from the 16 storage subspaces, and the second content and the directory are correspondingly stored in the storage subspace.

It should be noted that when the second content and the directory are correspondingly stored in the determined storage space by using the solution provided in this embodiment of the present invention, a case in which a storage space addressed according to the first content is fully occupied may occur. To successfully store the directory in such a case, a specific implementation manner of the foregoing step 24 may include:

first, determining whether the determined storage space in which the addressing address matches the first content has stored another directory; and

then, if a result of the determining is no, correspondingly storing the second content and the directory corresponding to the data block in the determined storage space, where the data block is accessed by the remote node; and if the result of the determining is yes, correspondingly storing the second content and the directory corresponding to the data block in the determined storage space after the determined storage space is freed.

According to the foregoing method provided in this embodiment of the present invention, a bit number of a first specific bit is set to be greater than a predetermined bit number threshold and less than a total bit number of a storage address of a data block. Therefore, when addressing is performed according to the bit number of the first specific bit, the maximum number of different addressing addresses that can be addressed does not exceed the maximum number of different addressing addresses that can be addressed according to a bit number of the storage address of the data block; in addition, the maximum number of the different addressing addresses that can be addressed is not less than a sum of the maximum number of data blocks that can be buffered by each CPU in all remote nodes either, where the remote nodes are in a same CC-NUMA system with a local node. Therefore, compared with a full directory technology in the prior art, the solution provided in this embodiment of the present invention reduces impact caused by an insufficient directory storage space of an NC on using, by a CPU, data of a remote node and buffered by the CPU, and greatly reduces the number of demands of a directory for storage resources.

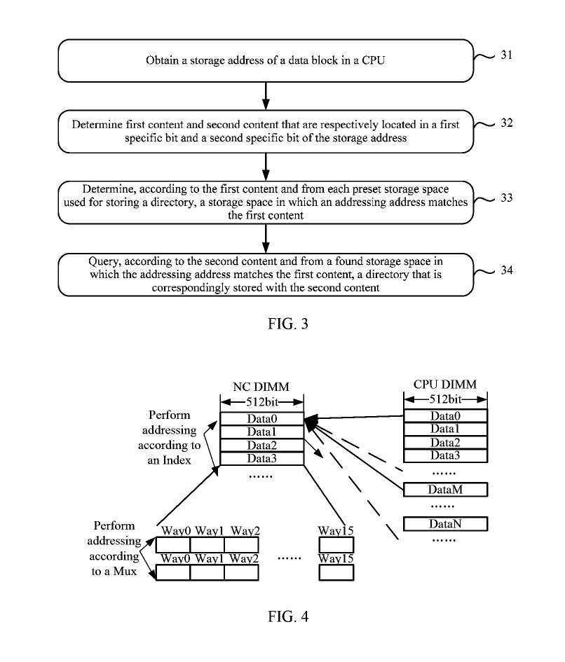

Based on a same invention idea as that of the directory storage method provided in the embodiment of the present invention, an embodiment of the present invention further provides a directory query method. The method specifically includes the following steps shown in FIG. 3:

Step 31: An NC in a local node obtains a storage address of a data block in a CPU in the local node.

Step 32: Determine first content and second content that are respectively located in a first specific bit and a second specific bit of the storage address, where the first content and the second content jointly include all content of the storage address, and a bit number of the first specific bit is greater than a predetermined bit number threshold and less than a total bit number of the storage address, where the bit number threshold satisfies: the total number of different storage spaces that can be addressed according to the bit number threshold is not less than a sum of the maximum number of data blocks that can be buffered by each CPU in all remote nodes, where the remote nodes are in a same CC-NUMA system with the local node.

Step 33: Query, according to the first content and from each preset storage space used for storing a directory, a storage space in which an addressing address matches the first content, where the total number of the preset storage spaces may generally be equal to the total number of different addressing addresses that can be addressed according to the bit number of the first specific bit.

Step 34: Query, according to the second content and from a found storage space in which the addressing address matches the first content, a directory that is correspondingly stored with the second content. The directory described herein is used for recording a condition in which the data block which is described in step 31 is buffered by a remote node.

Optionally, if the first content includes a first index portion and a second index portion, a specific implementation manner of the foregoing step 33 may include the following steps:

first, querying, according to the first index portion and from each preset storage space set used for storing a directory, a storage space set in which the addressing address matches the first index portion; and

then, querying, according to the second index portion and from a found storage space set in which the addressing address matches the first index portion, a storage space in which the addressing address matches the second index portion.

Optionally, if the storage space is divided according to a predetermined storage space division manner, a specific implementation process of step 34 may include:

querying, according to the second content and from multiple storage subspaces, the directory that is correspondingly stored with the second content, where the multiple storage subspaces are obtained by dividing, according to the predetermined storage space division manner, the determined storage space in which the addressing address matches the first content.

To describe in detail a practical application of the foregoing solutions provided in the embodiments of the present invention, the following focuses on embodiments of the solutions in the practical application.

### Embodiment 1

In Embodiment 1, it is assumed that every 512-Bit data in a DIMM used for expanding a CPU memory (CPU DIMM for short in the following) forms one Cache Line (equivalent to the foregoing data block), and each Cache Line uniquely corresponds to one storage address of the CPU. In addition, it is assumed that after data of a Cache Line is accessed by a remote node, an NC of a node corresponding to the CPU needs to store a corresponding directory in a storage space of the NC, so as to record a condition in which the data that is of the Cache Line is buffered by the remote node. For example, the NC needs to record by which remote node the data is buffered, and whether the data is monopolized by the remote node or shared by the remote node with one or more other remote nodes.

In the foregoing scenario, to resolve a problem in the prior art that a great number of demands for storage resources are generated because of an intention to reduce impact caused by an insufficient directory storage space of an NC on using, by a CPU, data of a remote node and buffered by the CPU in Embodiment 1, the CPU DIMM and a DIMM used for expanding a storage space of the NC (NC DIMM for short in the following) are mapped according to a mapping manner shown in FIG. 4. FIG. 4 is described as follows:

Each storage space set that is in the NC DIMM and can store 512-Bit data includes two 16-way set associative storage spaces. The storage space is referred to as a Cache in the following. Further, each Cache is divided into 16 parts whose identifiers are Way0 to Way15 separately, and each part is equivalent to the storage subspace described above. Way0 to Way15 may be referred to as a 16-way directory storage.

In FIG. 4, a mapping manner between a storage space in the CPU DIMM and a storage space set in the NC DIMM includes the following: In a storage address separately and uniquely corresponding to each Cache Line in the CPU DIMM, first index content in a first specific bit, also referred to as Index, is used as an addressing address for addressing each storage space set that is in the NC DIMM and can store 512-Bit data; and in a storage address separately and uniquely corresponding to each Cache Line in the CPU DIMM, second index content in the first specific bit, also referred to as Mux, is used as an addressing address for addressing a storage space included in each storage space set that is in the NC DIMM and can store 512-Bit data. In addition, in the storage address separately and uniquely corresponding to each Cache Line in the CPU DIMM, content in a second specific bit is used as content that is correspondingly stored with a directory in the NC DIMM. The content in the second specific bit may be referred to as Tag. It should be noted that the content in the first specific bit (that is, the first content described in the embodiments of the present invention) and the content in the second specific bit (that is, the second content described in the embodiments of the present invention) jointly include all content of a data storage address, so as to enable one storage address to be uniquely determined according to the first content and the second content, that is, one directory storage space is uniquely determined.

By using the mapping manner shown in FIG. 4, first, a mapping relationship between storage addresses separately corresponding to multiple Cache Lines in the CPU DIMM and addresses of a same storage space set in the NC DIMM is established according to the Index; further, if it is necessary to subdivide the storage space set, a mapping relationship between the storage addresses separately corresponding to the multiple Cache Lines in the CPU DIMM and storage spaces included in the storage space set may be established according to the Mux; still further, a mapping relationship between the storage addresses separately corresponding to the multiple Cache Lines in the CPU DIMM and storage subspaces included in the storage space set may further be established according to the Tag.

By using the mapping manner shown in FIG. 4, result in that the NC DIMM is doubled in depth and halved in width.

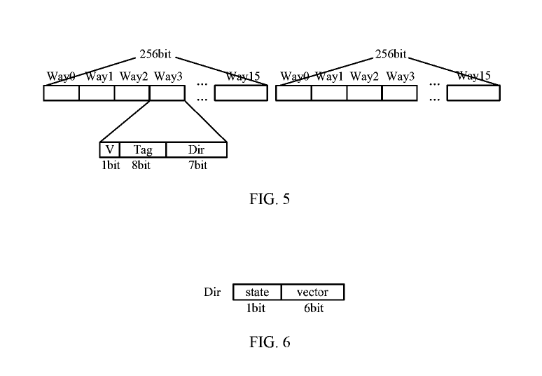

In Embodiment 1, a format of information stored in any storage subspace of Way0 to Way15 is shown in FIG. 5. In FIG. 5, the information stored in each storage subspace includes: a 1-Bit directory state indication identifier V, an 8-Bit Tag, and a 7-Bit Dir. FIG. 5 is specifically described as follows:

The directory state indication identifier V is used to represent whether a directory which is in a same storage subspace together with the directory state indication identifier is in a valid state. Generally, in an initial phase in which no directory is stored in the NC, all directory state indication identifiers V in the NC DIMM are used to separately represent that corresponding directories are in an invalid state.

The Tag is the second content described above. In Embodiment 1, one storage space set in the NC DIMM maps to directories corresponding to more than 32 Cache Lines. Therefore, for the storage addresses separately corresponding to the multiple Cache Lines, when a storage space is addressed according to the Index and the Mux that are determined from the storage addresses, a case in which the storage addresses separately corresponding to the multiple Cache Lines simultaneously map a same storage space may occur. In this case, it is further necessary to perform Tag matching, and consequently one directory corresponding to the Cache Line is uniquely located according to implementation of the Index, the Mux, and the Tag.

The Dir is a directory. In 7 bits used for storing the Dir, 1 bit may be allocated to serve as a state bit, to store information for representing that data is in an exclusive state or a shared state; and the other 6 bits are used for storing information for representing a storage location of the data in a remote node. A specific schematic division diagram of the 7 bits used for storing the Dir is shown in FIG. 6. The information for representing the storage location of the data in the remote node is a vector with a length of 6 bits.

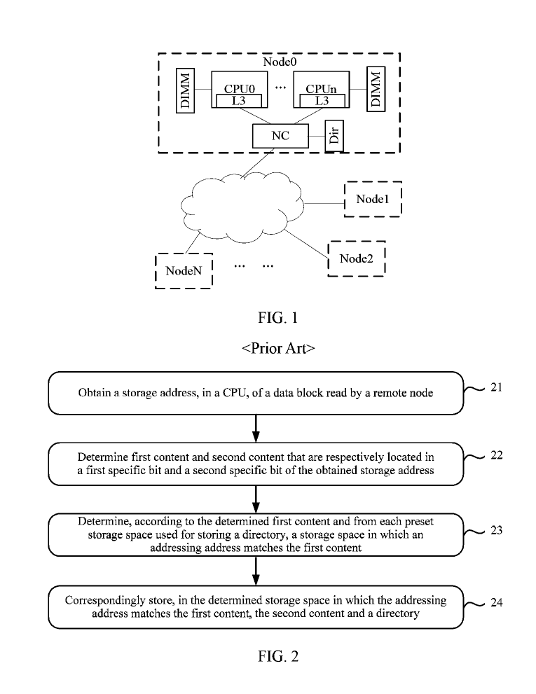

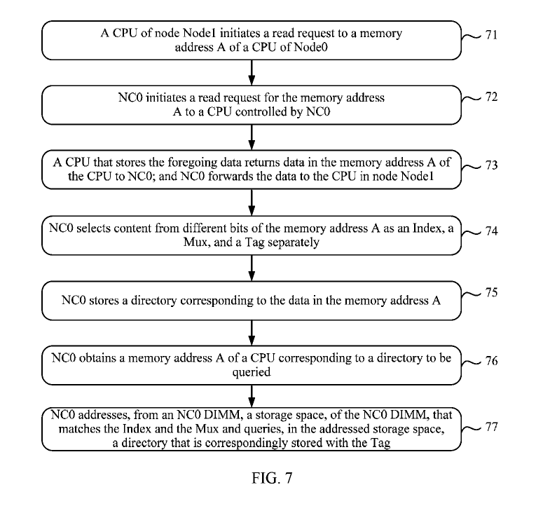

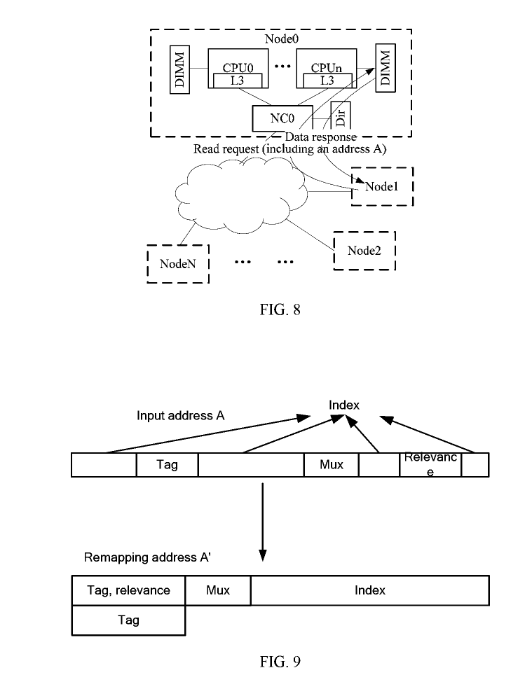

Based on the foregoing mapping relationship in Embodiment 1, FIG. 7 shows a simple implementation process of a data read operation across nodes in the CC-NUMA system shown in FIG. 1. It should be noted that the data read operation specifically refers to a read request for a memory address A initiated by a CPU of Node1 to a CPU of Node0, which is shown in FIG. 8.

Specifically, the implementation process of the data read operation across nodes shown in FIG. 7 specifically includes the following main steps:

Step 71: In an initial state of the CC-NUMA system, the CPU of the node Node1 initiates the read request for the memory address A to the CPU of Node0, where the read request includes the address A that points to a Cache Line uniquely corresponding to the address A.

In Embodiment 1, it may be assumed that when the CC-NUMA system is in the initial state, all directory state indication identifiers V separately represent that corresponding directories are in an invalid state.

Step 72: After NC0 receiving the read request for the memory address A, NC0 initiates the read request for the memory address A to the CPU controlled by NC0 because all found directory state indication identifiers V separately represent that corresponding directories are in an invalid state, that is, no remote node buffers a copy of data saved in the memory address A.

Step 73: A CPU that stores the foregoing data returns the data in the memory address A of the CPU to NC0; and NC0 forwards the data to the CPU in the node Node1.

Step 74: NC0 selects, according to a selecting manner shown in FIG. 9, content from different bits of the memory address A to serve as an Index, a Mux, and a Tag separately, thereby obtaining a remapping address A′ shown in FIG. 9.

It should be noted that in Embodiment 1, in consideration of the fact that generally a consecutive query manner is adopted subsequently to query directories corresponding to Cache Lines in the CPU of Node0, that is, directories corresponding to multiple Cache Lines, in the CPU of Node0, with consecutive addresses may be queried, content in some bits may be selected from the memory address A as content “relevance” shown in FIG. 9 when a directory is stored. When a directory is being queried subsequently, multiple directories may be found once according to a bit number of the “relevance” and stored in a memory of Node0, so as to match the consecutive query manner and improve query efficiency. In Embodiment 1, the “relevance” may be considered as a part of the Tag.

In Embodiment 1, content in several bits of low bits of the memory address A may be selected as the relevance. For example, content in two bits [1:0] is selected as the “relevance”. For the memory address A and multiple memory addresses similar to the memory address A, when content in other bits, except the two bits [1:0], in these memory addresses is same, the content in the two bits [1:0] is directories of data saved in four memory addresses 00, 01, 10, and 11 separately, and the directories are stored in a storage subspace with consecutive addresses in the NC DIMM.

In addition, content in a part of high bits in the memory address A may be selected as the Tag. In this way, it can be ensured that storage subspaces in a same storage space are not frequently in competition when data is in a consecutively accessed mode.

In Embodiment 1, content in 1 bit of the memory address A may further be selected as the Mux. Generally, it is not suitable to select content in an excessively high bit of the memory address A as the Mux. The reason is that if the content in the excessively high bit of the memory address A is selected as the Mux, directories corresponding to two Cache Lines, in the CPU DIMM, with consecutive addresses may be eventually stored in different storage spaces with a long distance between addresses, making it inconvenient to perform consecutive query on the directories subsequently.

Step 75: NC0 stores, according to the remapping address A′ obtained by performing step 74, a directory corresponding to the data in the memory address A.

Specifically, a storage space set may be determined in an NC0 DIMM according to the Index in the remapping address A; further, a storage space may further be determined from the determined storage space set according to the Mux in the remapping address A; and further, the Tag and the directory corresponding to the data in the memory address A may be stored in a storage subspace of the determined storage space. It should be noted that after the Tag and the directory are stored, a directory state indication identifier V in the storage subspace is set to represent that the directory is in a valid state; in addition, a state bit state in the storage subspace is also set according to information in which the data is in an exclusive or shared state; in addition, a vector is also set according to information about a storage location of the data in a remote node.

In Embodiment 1, in a process of performing step 75, after a storage space is determined according to the Index and the Mux, if NC0 finds that directory state indication identifiers V in all storage subspaces included in the storage space are currently set to represent that the directories are in a valid state, that is, the storage space is occupied, NC0 may select and free a storage subspace from all the storage subspaces included in the storage space, and store the Tag and the directory of the data in the freed storage subspace, so as to achieve “competition” for the storage subspace among different directories.

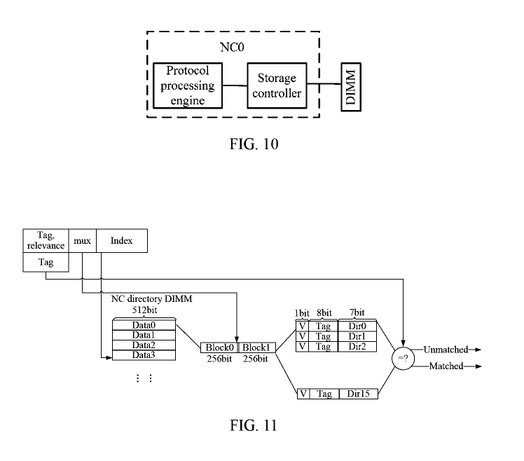

In Embodiment 1, step 75 may be implemented by disposing a protocol processing engine in NC0, as shown in FIG. 10. The directory is stored in the NC0 DIMM that is used to expand a memory of NC0. Therefore, a storage controller shown in FIG. 10 may further be disposed in NC0, to implement subsequent directory query.

After the foregoing step 71 to step 75 are performed, NC0 completes storing of the directory corresponding to the data in the memory address A. Subsequent step 76 and step 77 are further described in the following to illustrate how to query the directory.

Step 76: NC0 obtains a memory address A of a CPU corresponding to a directory to be queried.

Step 77: According to an addressing manner shown in FIG. 11, NC0 addresses, from an NC0 DIMM, a storage space that is in the NC0 DIMM and matches the Index and the Mux, and queries, in the addressed storage space, a directory that is correspondingly stored with the Tag; if it is found that the storage space has the directory that is correspondingly stored with the Tag, the directory may be acquired; and if it is found that the storage space does not have the directory that is correspondingly stored with the Tag, it is determined that the directory has not been stored.

In step 77, the Index, the Mux, and the Tag are determined according to the memory address A.

Compared with a full directory technology in the prior art, it can be learned that, according to the prior art, if it is assumed that each Cache Line respectively corresponds to one directory with a size of 8 bits, a ratio of a capacity of a CPU DIMM to a capacity of an NC DIMM is 64:1. That is, a 2 TByte CPU DIMM needs a 32 GByte NC DIMM. However, in a case in which the solution in Embodiment 1 of the present invention is adopted to implement storage by means of competition among directories, if a length of a Tag is 8 bits, a length of a V is 1 Bit, and a length of a Dir is 7 bits, a ratio of a capacity of a CPU DIMM to a capacity of a NC DIMM is (32*2̂4)/1=(2̂9)/1. That is, a 2 TByte CPU DIMM merely needs a 4 GByte NC DIMM. In view of this, by adopting the solution provided in this embodiment of the present invention, a demand of a directory for the NC DIMM is obviously reduced.

### Embodiment 2

Compared with Embodiment 1, a main difference between Embodiment 2 and Embodiment 1 is that a mapping manner between an address of a Cache Line and an address of a storage space in an NC DIMM is different.

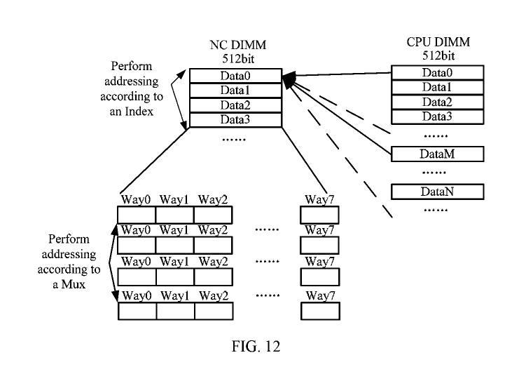

Specifically, the mapping manner between an address of a Cache Line and an address of a storage space in an NC DIMM in Embodiment 2 is shown in FIG. 12. A description of the mapping relationship shown in FIG. 12 is similar to the foregoing description of the mapping relationship shown in FIG. 4. Details are not described herein again.

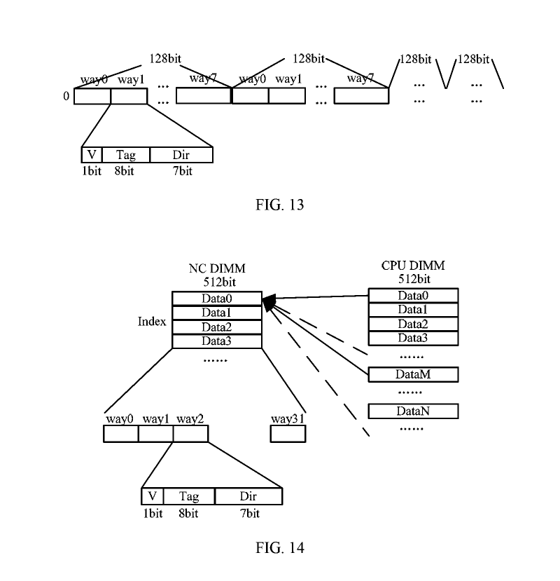

It can be learned from the mapping relationship shown in FIG. 12 that a bit number of a Mux is 2 in Embodiment 2. Therefore, in Embodiment 2, each storage space set that is addressed according to an Index and the Mux includes 4 storage spaces, where each storage space is divided into 8 storage subspaces, as shown in FIG. 13.

In Embodiment 2, if it is assumed that each Cache Line respectively corresponds to one directory with a size of 8 bits, a length of a Tag is 8 bits, a length of a V is 1 Bit, and a length of a Dir is 7 bits, a ratio of a capacity of a CPU DIMM to a capacity of the NC DIMM is (32*2̂5)/1=(2̂10)/1, that is, a 2 TByte CPU DIMM merely needs a 2 GByte NC DIMM.

### Embodiment 3

Compared with Embodiment 1 and Embodiment 2, a main difference between Embodiment 3 and Embodiment 1 as well as Embodiment 2 is that a mapping manner between an address of a Cache Line and an address of a storage space in an NC DIMM is different.

Specifically, the mapping manner between an address of a Cache Line and an address of a storage space in an NC DIMM in Embodiment 3 is shown in FIG. 14. A description of the mapping relationship shown in FIG. 14 is similar to the foregoing description of the mapping relationships shown in FIG. 4 and FIG. 12. Details are not described herein again.

It can be learned from the mapping relationship shown in FIG. 14 that no content is selected from the address of the Cache Line as a Mux in Embodiment 3. Therefore, in Embodiment 3, each storage space set that is addressed according to an Index and the Mux includes 1 storage space, where the storage space is divided into 32 storage subspaces.

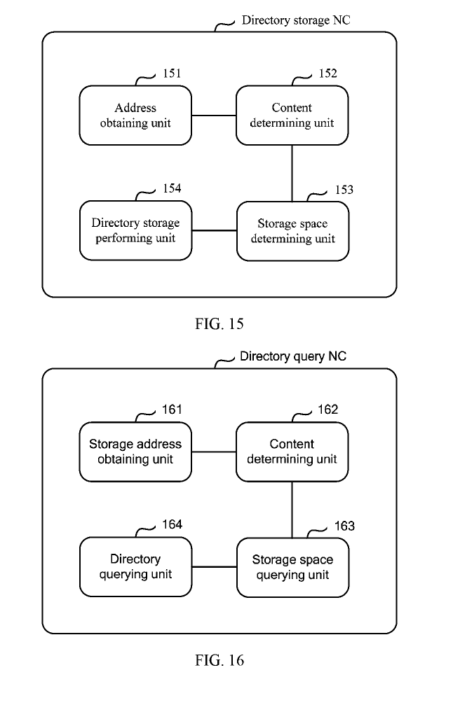

Based on a same invention idea as that of the directory storage method provided in the embodiment of the present invention, this embodiment of the present invention further provides a directory storage NC, which is used to resolve a problem in the prior art that a great number of demands for storage resources are generated because of an intention to reduce impact caused by an insufficient directory storage space of the NC on using, by a CPU, data of a remote node and buffered by the CPU. The directory described herein is used for recording a condition in which a data block in a CPU in a local node is buffered by a remote node, where the local node is a node on which the directory storage NC is located. Specifically, a schematic diagram of a specific structure of the NC is shown in FIGS. 15, and the NC includes an address obtaining unit 151, a content determining unit 152, a storage space determining unit 153, and a directory storage performing unit 154. An introduction to specific functions of these units is as follows:

The address obtaining unit 151 is configured to obtain a storage address of a data block in a CPU, where the data block is read by a remote node and is in the CPU.

The content determining unit 152 is configured to determine first content and second content that are respectively located in a first specific bit and a second specific bit of the storage address, where the first content and the second content jointly include all content of the storage address, and a bit number of the first specific bit is greater than a predetermined bit number threshold and is less than a total bit number of the storage address, where the bit number threshold satisfies: the total number of different storage spaces that can be addressed according to the bit number threshold is not less than a sum of the maximum number of data blocks that can be buffered by each CPU in all remote nodes, where the remote nodes are in a same CC-NUMA system with the local node.

The storage space determining unit 153 is configured to determine, according to the first content and from each preset storage space used for storing a directory, a storage space in which an addressing address matches the first content.

The directory storage performing unit 154 is configured to correspondingly store the second content and the directory in the determined storage space.

Optionally, when the first content includes a first index portion and a second index portion, the storage space determining unit 153 may be specifically configured to: determine, according to the first index portion and from each preset storage space set used for storing a directory, a storage space set in which the addressing address matches the first index portion; and determine, according to the second index portion and from the determined storage space set, a storage space in which the addressing address matches the second index portion.

Optionally, the directory storage performing unit 154 may be specifically configured to: determine one storage subspace from multiple storage subspaces obtained by dividing the determined storage space according to a predetermined storage space division manner; and correspondingly store the second content and the directory in the determined storage subspace.

Optionally, the directory storage performing unit 154 may be specifically configured to: determine whether the determined storage space has stored another directory; when it is determined that the determined storage space has not stored another directory, correspondingly store the second content and the directory in the determined storage space; and when it is determined that the determined storage space has stored another directory, correspondingly store the second content and the directory in the determined storage space after the determined storage space is freed.

Based on the invention idea of the directory query method provided in the embodiment of the present invention, this embodiment of the present invention further provides a directory query NC. A schematic diagram of a specific structure of the directory query NC is shown in FIG. 16; and the directory query NC includes a storage address obtaining unit 161, a content determining unit 162, a storage space querying unit 163, and a directory querying unit 164. An introduction to functions of these units is as follows:

The storage address obtaining unit 161 is configured to obtain a storage address of a data block in a CPU, where the CPU described herein is a CPU in a local node on which the directory query NC is located.

The content determining unit 162 is configured to determine first content and second content that are respectively located in a first specific bit and a second specific bit of the storage address, where the first content and the second content jointly include all content of the storage address, and a bit number of the first specific bit is greater than a predetermined bit number threshold and is less than a total bit number of the storage address, where the bit number threshold satisfies: the total number of different storage spaces that can be addressed according to the bit number threshold is not less than a sum of the maximum number of data blocks that can be buffered by each CPU in all remote nodes, where the remote nodes are in a same CC-NUMA system with the local node.

The storage space querying unit 163 is configured to query, according to the first content and from each preset storage space used for storing a directory, a storage space in which an addressing address matches the first content.

The directory querying unit 164 is configured to query, according to the second content and from a found storage space in which the addressing address matches the first content, a directory that is correspondingly stored with the second content, where the directory is used for recording a condition in which a data block is buffered by a remote node.

Optionally, when the first content includes a first index portion and a second index portion, the storage space querying unit 163 may be specifically configured to:

query, according to the first index portion and from each preset storage space set used for storing a directory, a storage space set in which the addressing address matches the first index portion; and

query, according to the second index portion and from a found storage space set in which the addressing address matches the first index portion, a storage space in which the addressing address matches the second index portion.

Optionally, the directory querying unit 164 may be specifically configured to:

query, according to the second content and from multiple storage subspaces, the directory that is correspondingly stored with the second content, where the multiple storage subspaces are obtained by dividing, according to a predetermined storage space division manner, the determined storage space in which the addressing address matches the first content.

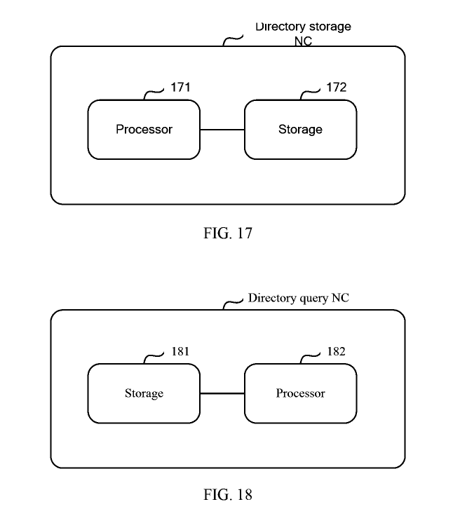

Based on the same invention idea as that of the directory storage method provided in the embodiment of the present invention, this embodiment of the present invention further provides a directory storage NC, which is used to resolve a problem in the prior art that a great number of demands for storage resources are generated because of an intention to reduce impact caused by an insufficient directory storage space of the NC on using, by a CPU, data of a remote node and buffered by the CPU. The directory described herein is used for recording a condition in which a data block in a CPU in a local node is buffered by a remote node, where the local node is a node on which the directory storage NC is located. Specifically, a schematic diagram of a specific structure of the NC is shown in FIG. 17. The NC includes a processor 171 and a storage 172. An introduction to specific functions of these functional entities is as follows:

The processor 171 is configured to: obtain a storage address of a data block in a CPU, where the data block is read by a remote node and is in the CPU; determine first content and second content that are respectively located in a first specific bit and a second specific bit of the storage address; determine, according to the first content and from each preset storage space that is of the storage 172 and used for storing a directory, a storage space in which an addressing address matches the first content; and correspondingly store the second content and a directory in the determined storage space.

The storage 172 is configured to store the second content and the directory.

It should be noted that:

the first content and the second content jointly include all content of the storage address;

a bit number of the first specific bit is greater than a predetermined bit number threshold and is less than a total bit number of the storage address; and

the bit number threshold satisfies: the total number of different storage spaces that can be addressed according to the bit number threshold is not less than a sum of the maximum number of data blocks that can be buffered by each CPU in all remote nodes, where the remote nodes are in a same CC-NUMA system with a local node.

In this embodiment of the present invention, the NC may exclude the storage 172, that is, a storage configured to store a directory may not serve as a part of the NC but to be independent of the NC and to exist as a storage.

Optionally, when the first content includes a first index portion and a second index portion, the processor 171 may be specifically configured to: determine, according to the first index portion and from each preset storage space set used for storing a directory, a storage space set in which the addressing address matches the first index portion; and determine, according to the second index portion and from the determined storage space set, a storage space in which the addressing address matches the second index portion.

Optionally, the processor 171 may be specifically configured to: determine one storage subspace from multiple storage subspaces obtained by dividing the determined storage space according to a predetermined storage space division manner; and correspondingly store the second content and the directory in the determined storage subspace.

Optionally, the processor 171 may be specifically configured to: determine whether the determined storage space has stored another directory; when it is determined that the determined storage space has not stored another directory, correspondingly store the second content and the directory in the determined storage space; and when it is determined that the determined storage space has stored another directory, correspondingly store the second content and the directory in the determined storage space after the determined storage space is freed.

Based on the invention idea of the directory query method provided in the embodiment of the present invention, this embodiment of the present invention further provides a directory query NC. A schematic diagram of a specific structure of the directory query NC is shown in FIG. 18; and the directory query NC includes a storage 181 and a processor 182. An introduction to functions of these functional entities is as follows:

The storage 181 is configured to store a directory, where the directory is used for recording a condition in which a data block is buffered by a remote node.

The processor 182 is configured to: obtain a storage address of the data block in a CPU (the CPU described herein is a CPU in a local node on which the directory query NC is located); determine first content and second content that are respectively located in a first specific bit and a second specific bit of the storage address; query, from each preset storage space used for storing a directory, a storage space in which an addressing address matches the first content; and query, according to the second content and from a found storage space that is of the storage 181 and in which the addressing address matches the first content, a directory that is correspondingly stored with the second content.

It should be noted that:

the first content and the second content jointly include all content of the storage address;

a bit number of the first specific bit is greater than a predetermined bit number threshold and is less than a total bit number of the storage address; and

the bit number threshold satisfies: the total number of different storage spaces that can be addressed according to the bit number threshold is not less than a sum of the maximum number of data blocks that can be buffered by each CPU in all remote nodes, where the remote nodes are in a same CC-NUMA system with the local node.

In this embodiment of the present invention, the NC may exclude the storage 181, that is, the storage 181 may not serve as a part of the NC but to be independent of the NC and to exist as a storage.

Optionally, when the first content includes a first index portion and a second index portion, the processor 182 may be specifically configured to:

query, according to the first index portion and from each preset storage space set used for storing a directory, a storage space set in which the addressing address matches the first index portion; and

query, according to the second index portion and from a found storage space set in which the addressing address matches the first index portion, a storage space in which the addressing address matches the second index portion.

Optionally, the processor 182 may be specifically configured to:

query, according to the second content and from multiple storage subspaces, the directory that is correspondingly stored with the second content, where the multiple storage subspaces are obtained by dividing, according to a predetermined storage space division manner, the determined storage space in which the addressing address matches the first content.

In the foregoing solutions provided in this embodiment of the present invention, a bit number of a first specific bit is set to be greater than a predetermined bit number threshold and less than a total bit number of a data storage address; and the total number of different storage spaces that can be addressed according to the bit number threshold is not less than a sum of the maximum number of data blocks that can be buffered by each CPU in all remote nodes, where the remote nodes are in a same CC-NUMA system with a local node. Therefore, when addressing is performed according to the bit number of the first specific bit, the maximum number of different addressing addresses that can be addressed does not exceed the maximum number of different addressing addresses that can be addressed according to a bit number of the data storage address; in addition, the maximum number of the different addressing addresses that can be addressed is not less than the sum of the maximum number of the data blocks that can be buffered by each CPU in all remote nodes either, where the remote nodes are in the same CC-NUMA system with the local node. Therefore, compared with a full directory technology in the prior art, the solutions provided in this embodiment of the present invention reduce impact caused by an insufficient directory storage space of an NC on using, by a CPU, data of a remote node and buffered by the CPU and greatly reduce the number of demands of a directory for storage resources.

It is understandable by a person skilled in the art that embodiments of the present invention may be provided as methods, systems, or computer programs. Therefore, the present invention may adopt forms of complete hardware embodiments, complete software embodiments, or embodiments combining software and hardware. Further, the present invention may adopt forms of computer program products implemented in one or multiple computer available storage media (including but not limited to disk memories, CD-ROMs, optical memories, and the like) including computer available program code.

The present invention is described according to flowcharts and/or block diagrams of methods, devices (systems), and computer program products provided in embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided to a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device so that a series of operations and steps are executed on the computer or the other programmable device so as to generate computer-implemented processing. Thereby, the instructions executed on the computer or the other programmable device provide steps for implementing a specific function in one or more processes in the flowcharts and/or in one or more blocks in the block diagrams.

Although some preferred embodiments of the present application have been described, a person skilled in the art can make changes and modifications to these embodiments once learning the basic inventive concept. Therefore, the following claims are intended to be explained as to cover the preferred embodiments and all changes and modifications falling within the scope of the present application.

It is apparent that a person skilled in the art can make various modifications and variations to the present invention without departing from the spirit and scope of the present invention. The present invention is intended to cover these modifications and variations provided that they fall in the scope of protection defined by the following claims or their equivalents.

What is claimed is:

1. A directory storage method, wherein the directory is used for recording a condition in which a data block in a central processing unit CPU is buffered by a remote node, and comprising:
obtaining, by a node controller NC in the local node, a storage address of the data block in the CPU, wherein the data block is read by the remote node and is in the CPU;
determining first content and second content that are respectively located in a first specific bit and a second specific bit of the storage address, wherein the first content and the second content jointly comprise all content of the storage address, and a bit number of the first specific bit is greater than a predetermined bit number threshold and is less than a total bit number of the storage address, wherein the bit number threshold satisfies: the total number of different storage spaces that can be addressed according to the bit number threshold is not less than a sum of the maximum number of data blocks that can be buffered by each CPU in all remote nodes, wherein the remote nodes are in a same cache coherence non-uniform memory access CC-NUMA system with the local node;
determining, according to the first content and from each preset storage space used for storing a directory, a storage space in which an addressing address matches the first content; and
correspondingly storing the second content and the directory in the determined storage space.

2. The method according to claim 1, wherein the first content comprises a first index portion and a second index portion; and
the determining, according to the first content and from each preset storage space used for storing a directory, a storage space in which an addressing address matches the first content specifically comprises:
determining, according to the first index portion and from each preset storage space set used for storing a directory, a storage space set in which the addressing address matches the first index portion; and
determining, according to the second index portion and from the determined storage space set, a storage space in which the addressing address matches the second index portion.

3. The method according to claim 1, wherein the correspondingly storing the second content and the directory in the determined storage space specifically comprises:
determining one storage subspace from multiple storage subspaces obtained by dividing the determined storage space according to a predetermined storage space division manner; and
correspondingly storing the second content and the directory in the determined storage subspace.

4. The method according to claim 1, wherein the correspondingly storing the second content and the directory in the determined storage space specifically comprises:
determining whether the determined storage space has stored another directory;
when it is determined that the determined storage space has not stored another directory, correspondingly storing the second content and the directory in the determined storage space; and
when it is determined that the determined storage space has stored another directory, correspondingly storing the second content and the directory in the determined storage space after the determined storage space is freed.

5. A directory query method, comprising:
obtaining, by a node controller NC in a local node, a storage address of a data block in a central processing unit CPU in the local node;
determining first content and second content that are respectively located in a first specific bit and a second specific bit of the storage address, wherein the first content and the second content jointly comprise all content of the storage address, and a bit number of the first specific bit is greater than a predetermined bit number threshold and is less than a total bit number of the storage address, wherein the bit number threshold satisfies: the total number of different storage spaces that can be addressed according to the bit number threshold is not less than a sum of the maximum number of data blocks that can be buffered by each CPU in all remote nodes, wherein the remote nodes are in a same cache coherence non-uniform memory access CC-NUMA system with the local node;
querying, according to the first content and from each preset storage space used for storing a directory, a storage space in which an addressing address matches the first content; and
querying, according to the second content and from a found storage space in which the addressing address matches the first content, a directory that is correspondingly stored with the second content, wherein the directory is used for recording a condition in which a data block is buffered by a remote node.

6. The method according to claim 5, wherein the first content comprises a first index portion and a second index portion, and
the querying, according to the first content and from each preset storage space used for storing a directory, a storage space in which an addressing address matches the first content specifically comprises:
querying, according to the first index portion and from each preset storage space set used for storing a directory, a storage space set in which the addressing address matches the first index portion; and
querying, according to the second index portion and from a found storage space set in which the addressing address matches the first index portion, a storage space in which the addressing address matches the second index portion.

7. The method according to claim 5, wherein the querying the directory according to the second content and from the found storage space in which the addressing address matches the first content specifically comprises:
querying, according to the second content and from multiple storage subspaces, the directory that is correspondingly stored with the second content, wherein the multiple storage subspaces are obtained by dividing, according to a predetermined storage space division manner, the determined storage space in which the addressing address matches the first content.

8. A directory storage node controller, wherein the directory is used for recording a condition in which a data block in a central processing unit CPU in a local node is buffered by a remote node, the local node is a node on which the node controller is located, and the node controller comprises:
an address obtaining unit, configured to obtain a storage address of the data block in the CPU, wherein the data block is read by the remote node and is in the CPU;
a content determining unit, configured to determine first content and second content that are respectively located in a first specific bit and a second specific bit of the storage address, wherein the first content and the second content jointly comprise all content of the storage address, and a bit number of the first specific bit is greater than a predetermined bit number threshold and is less than a total bit number of the storage address, wherein the bit number threshold satisfies: the total number of different storage spaces that can be addressed according to the bit number threshold is not less than a sum of the maximum number of data blocks that can be buffered by each CPU in all remote nodes, wherein the remote nodes are in a same cache coherence non-uniform memory access CC-NUMA system with the local node;
a storage space determining unit, configured to determine, according to the first content and from each preset storage space used for storing a directory, a storage space in which an addressing address matches the first content; and
a directory storage performing unit, configured to correspondingly store the second content and the directory in the determined storage space.

9. The node controller according to claim 8, wherein the first content comprises a first index portion and a second index portion; and
the storage space determining unit is specifically configured to:
determine, according to the first index portion and from each preset storage space set used for storing a directory, a storage space set in which the addressing address matches the first index portion; and
determine, according to the second index portion and from the determined storage space set, a storage space in which the addressing address matches the second index portion.

10. The node controller according to claim 8, wherein the directory storage performing unit is specifically configured to:
determine one storage subspace from multiple storage subspaces obtained by dividing the determined storage space according to a predetermined storage space division manner; and
correspondingly store the second content and the directory in the determined storage subspace.

11. The node controller according to claim 8, wherein the directory storage performing unit is specifically configured to:
determine whether the determined storage space has stored another directory;
when it is determined that the determined storage space has not stored another directory, correspondingly store the second content and the directory in the determined storage space; and
when it is determined that the determined storage space has stored another directory, correspondingly store the second content and the directory in the determined storage space after the determined storage space is freed.

12. A directory query node controller, comprising:
a storage address obtaining unit, configured to obtain a storage address of a data block in a central processing unit CPU, wherein the CPU is a CPU in a local node on which the node controller is located;
a content determining unit, configured to determine first content and second content that are respectively located in a first specific bit and a second specific bit of the storage address, wherein the first content and the second content jointly comprise all content of the storage address, and a bit number of the first specific bit is greater than a predetermined bit number threshold and is less than a total bit number of the storage address, wherein the bit number threshold satisfies: the total number of different storage spaces that can be addressed according to the bit number threshold is not less than a sum of the maximum number of data blocks that can be buffered by each CPU in all remote nodes, wherein the remote nodes are in a same cache coherence non-uniform memory access CC-NUMA system with the local node;
a storage space querying unit, configured to query, according to the first content and from each preset storage space used for storing a directory, a storage space in which an addressing address matches the first content; and
a directory querying unit, configured to query, according to the second content and from a found storage space in which the addressing address matches the first content, a directory that is correspondingly stored with the second content, wherein the directory is used for recording a condition in which a data block is buffered by a remote node.

13. The node controller according to claim 12, wherein the first content comprises a first index portion and a second index portion; and
the storage space querying unit is specifically configured to:
query, according to the first index portion and from each preset storage space set used for storing a directory, a storage space set in which the addressing address matches the first index portion; and
query, according to the second index portion and from a found storage space set in which the addressing address matches the first index portion, a storage space in which the addressing address matches the second index portion.

14. The node controller according to claim 12, wherein the directory querying unit is specifically configured to:
query, according to the second content and from multiple storage subspaces, the directory that is correspondingly stored with the second content, wherein the multiple storage subspaces are obtained by dividing, according to a predetermined storage space division manner, the determined storage space in which the addressing address matches the first content.
